(19) United States
(12) Patent Application Publication
(10) Pub. No.: US 2009/0045217 A1
(43) Pub. Date: Feb. 19, 2009

(54) Musical soap dispenser

(76) Inventor: Nancy L. Bobrowski, California, MD (US)

Correspondence Address: JAMES RAY & ASSOCIATES, 2640 PITCAIRN ROAD, MONROEVILLE, PA, 15146, US

(21) Appl. No.: 12/283,874

(22) Filed: Sep. 16, 2008

Related U.S. Application Data
(63) Continuation-in-part of application No. 11/397,285, filed on Apr. 4, 2006.

(51) Int. Cl. B67D 5/00; B65D 88/54; A63H 5/00; A63H 33/00

(52) U.S. Cl. 222/39; 222/321.7; 446/397; 446/475

(57) ABSTRACT

An apparatus for dispensing soap and encouraging washing hands long enough to kill germs and bacteria. The apparatus comprises a container having a predetermined size and a predetermined shape for holding a predetermined volume of a liquid soap mixture. A dispensing means is engageable with the container for delivering a predetermined quantity of the liquid soap mixture, the dispensing means includes a pump member. There is a chip member disposed in such dispensing means and connected for activation by the pump member for providing a musical reminder on the importance of cleanliness.

### CROSS REFERENCE TO RELATED APPLICATIONS

This application is a Continuation-in-Part Application of co-pending patent application Ser. No. 11/397,285 filed Apr. 4, 2006.

### FIELD OF THE INVENTION

The present invention relates, in general, to a soap dispenser, and, more particularly, the present invention relates to a soap dispenser with a chip disposed in the cap portion that provides a melody when such dispenser is used to encourage children and even adults to wash their hands for a predetermined time.

### BACKGROUND OF THE INVENTION

It has widely recommended that all people wash their hands frequently to destroy many of the germs that cause viruses, colds and other diseases. However, even though this fact is well known many people, children and adults, merely go through the motion of washing their hands. Many just rinse their hands with water without using soap, while some merely wave their hands under a stream of water and go.

It is recommended by the CDC (Center For Disease Control) that people should wash their hands with an antibacterial soap and should wash their hands for a period of at least 15 seconds and probably even up to 20 seconds. It is difficult to get people to wash their hands for this period of time. For some people the 15 or 20 seconds may seem like an eternity. This problem is even more prevalent with children who are generally adverse to washing their hands anyway.

Thus, it would be advantageous if there were some means to encourage people, particularly children, to wash their hands and even more so to wash them long enough to kill germs.

### SUMMARY OF THE INVENTION

In a first aspect the present invention provides an apparatus for dispensing soap and encouraging washing hands long enough to kill germs and bacteria. The apparatus comprises a container having a predetermined size and a predetermined shape for holding a predetermined volume of a liquid soap mixture. A dispensing means is engageable with the container for delivering a predetermined quantity of the liquid soap mixture, the dispensing means includes a pump member. There is a chip member disposed within such cap member of such dispensing means and connected for activation by the pump member for providing a musical reminder on the importance of cleanliness.

In a second aspect the present invention provides in combination with a soap dispenser having a manually operable pump, a device for emitting sound. The device comprises a means disposed within a cap portion of the soap dispenser for storing and emitting sound signals and operable to emit such sound signal upon supply of a predetermined voltage. A battery is electrically connected to such means capable of supplying the predetermined voltage and an actuating means is operatively coupled between the battery and the means for storing and emitting sound signals and operable by a downward motion of such pump to supply such predetermined voltage.

### OBJECTS OF THE INVENTION

It is, therefore, one of the primary objects of the present invention to provide a soap dispenser which when activated will play a musical reminder to wash hands properly.

Another object of the present invention is to provide a soap dispenser which will play music for a predetermined period of time.

Still another object of the present invention is to provide a soap dispenser that will encourage children to wash their hands.

Yet another object of the present invention is to provide a soap dispenser that is activated when a pump handle is depressed.

Another object of the present invention is to provide a soap dispenser which will play the alphabet song so as to make washing hands appealing for young children.

These and various other objects and advantages of this invention will become apparent after a full reading of the following detailed description, particularly, when read in conjunction with the attached drawings as described below and the appended claims.

### BRIEF DESCRIPTION OF THE DRAWINGS

FIG. 1 is a perspective view of the apparatus according to an embodiment of the invention.

FIG. 2 is perspective view of the pump portion of the apparatus showing music coming from the apparatus.

FIG. 3 is a vertical partial cross-sectional view of the cap member portion of the soap dispenser showing the sound emitting device and the means for storing and emitting such sound along with the other necessary parts.

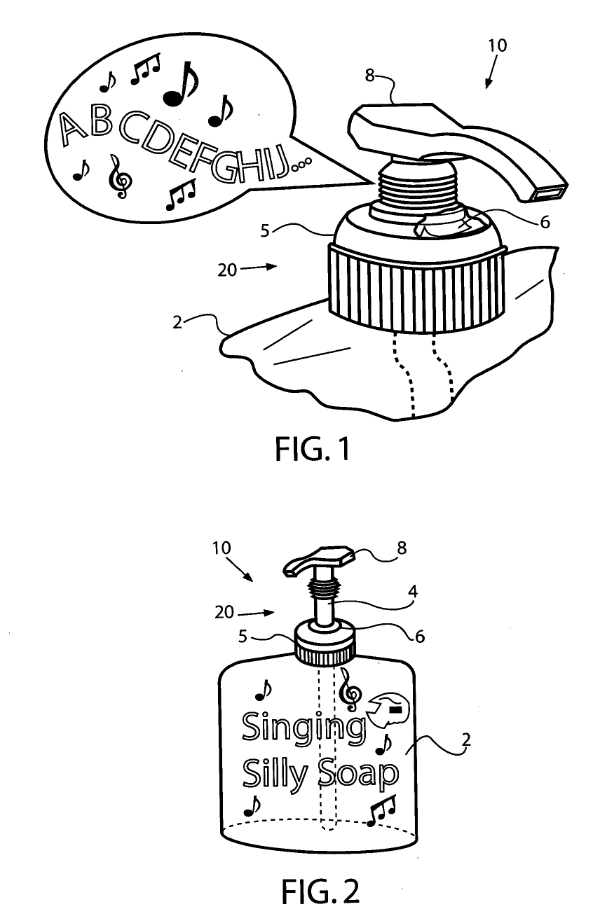

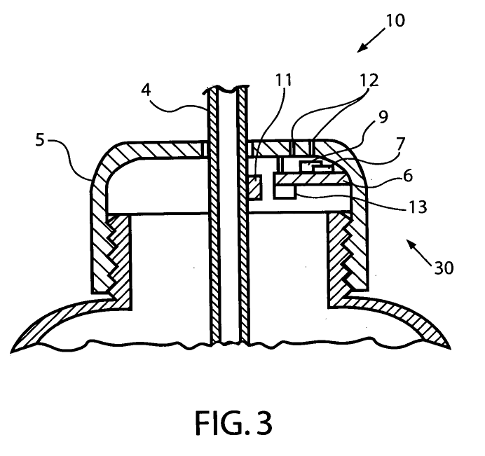

### BRIEF DESCRIPTION OF THE PRESENTLY PREFERRED AND ALTERNATE EMBODIMENTS OF THE INVENTION

Prior to proceeding with the more detailed description of the present invention it should be noted that, for the sake of clarity, identical components which have identical functions have been designated by identical reference numerals throughout the several views illustrated in the drawings.

The present invention provides an apparatus, generally designated 10, for dispensing soap and encouraging washing hands long enough to kill germs and bacteria. The apparatus 10 comprises a container 2 having a predetermined size and a predetermined shape for holding a predetermined volume of a liquid soap mixture. A dispensing means, generally designated 20, is engageable with the container for delivering a predetermined quantity of the liquid soap mixture, the dispensing means 20 includes a pump member 4. There is an integrated circuit microchip member 6 disposed in such dispensing means 20 and connected for activation by the actuating means (pump member) 4 for providing a musical reminder on the importance of cleanliness. Such microchip member 6 is disposed within such cap member 5 of such dispensing means 20 and is a means 6 for storing and emitting sound signals upon supply of a predetermined voltage. A battery 7, electrically coupled with the means 6 (microchip) is capable of supplying the predetermined voltage. There is an actuating means 30 operatively connected between such battery 7 and such means for storing and emitting sound signals 6 is operable by a downward motion of the pump member 4 to supply the predetermined voltage.

Such means 6 for storing and emitting sound signals is at least one integrated circuit semiconductor microchip 6. Further, such means 6 for storing and emitting sound signals includes a digital sound chip and a sound generator 9 electrically connected thereto. Such sound generator 9 is a piezoelectric transducer.

Such actuating means 30 includes a first member 11 disposed on an exterior surface of such dispenser shaft for movement therewith and a second member 13 operatively coupled with the means 6 for storing and emitting sound signals. Such first member 11 is a target or striker 11 and such second member 13 is a sensor or switch 13 for sensing such target (striker) 11 positioned in close proximity thereto. Such second member (switch) 13 is operable by contact with the first member (striker) 11. The means 6 for storing and emitting sound signals and such battery 7 are mounted internal to a cap of such dispenser 10. Such cap 5 further includes at least one aperture 12 formed through a portion thereof and generally aligned with such means 6 for storing and emitting sound signals for promulgating an emitted audible sound external to the soap dispenser.

Such microchip member 6 when actuated by depressing the handle 8 of the pump member 4 provides a musical reminder for a predetermined period of time. Such predetermined period of time is at least sufficient to kill most germs. It is generally believed by medical health personnel, such as the Center for Disease Control, that this time is a time of between about 15 and about 20 seconds.

Such pump member 4 has a handle 8 that is depressed to release the liquid antibacterial soap mixture as well as actuating the musical microchip member 6.

Such apparatus 10 is reusable. That is when the soap which is an antibacterial soap mixture is used up the apparatus can be refilled over and over again. Such container 2 is formed of one of plastic or glass. It is presently preferred that such container 2 is made of plastic and, further, that such plastic is blow molded.

It is also preferred that such musical reminder is a song. Since the apparatus 10 is primarily designed to encourage young children to wash their hands thoroughly it is recommended that such song be the alphabet song with possibly the following lyrics:
“ABCDEFG HIJKLMNOP QRS and TUV WXY and Z
Now I've washed my hands you see
Aren't you very proud of me”

Children need encouragement to wash their hands and possibly the above lyrics may cause them to sing along while they wash their hands and thus wash for such predetermined time of between 15 and 20 seconds as recommended by the Center for Disease Control.

While a presently preferred embodiment and alternate embodiments of the present invention has been described in detail above, it should be understood that various other adaptations and/or modifications of the invention can be made by those persons who are particularly skilled in the art without departing from either the spirit of the invention or the scope of the appended claims.

I claim:

1. An apparatus for dispensing soap and encouraging washing hands long enough to kill germs and bacteria, said apparatus comprising:
(a) a container having a predetermined size and a predetermined shape for holding a predetermined volume of a liquid soap mixture;
(b) a dispensing means engageable with said container for delivering a predetermined quantity of said liquid soap mixture, said dispensing means including a pump member;
(c) an integrated circuit microchip member disposed within said cap portion of said dispensing means and connected for activation by an actuating means disposed on said pump member for providing a musical reminder on the importance of cleanliness.

2. The apparatus, according to claim 1, wherein said micro-chip member when activated provides a musical reminder for a predetermined period of time.

3. The apparatus, according to claim 2, wherein said predetermined period of time is at least sufficient to kill most germs.

4. The apparatus, according to claim 2, wherein said predetermined period of time is a time between about 15 and about 20 seconds.

5. The apparatus, according to claim 1, wherein said actuating means includes a pump handle that is depressed to release said liquid soap mixture.

6. The apparatus, according to claim 1, wherein said apparatus is reusable.

7. The apparatus, according to claim 1, wherein said liquid soap mixture is an antibacterial soap mixture.

8. The apparatus, according to claim 2, wherein said musical reminder is a song.

9. The apparatus, according to claim 12, wherein said song is an alphabet song.

10. In combination with a soap dispenser having a manually operable pump, a device for emitting sound, said device comprising:
(a) a means disposed within a cap portion of said soap dispenser for storing and emitting sound signals and operable to emit said sound signal upon supply of predetermined voltage;
(b) a battery electrically connected to said means capable of supplying said predetermined voltage; and
(c) an actuating means operatively coupled between said battery and said means for storing and emitting sound signals and operable by a downward motion of said pump to supply said predetermined voltage.

11. The device, according to claim 10, wherein said means for storing and emitting sound signals is at least one integrated circuit semiconductor chip.

12. The device, according to claim 10, wherein said means for storing and emitting sound signals includes a digital sound chip and a sound generator electrically connected thereto.

13. The device, according to claim 12, wherein said sound generator is a piezoelectric transducer.

14. The device, according to claim 10, wherein said actuating means includes a first member disposed on an exterior surface of dispenser shaft for movement therewith and a second member operatively coupled to said means for storing and emitting sound signals.

15. The device, according to claim 14, wherein said first member is a target and wherein said second member is a sensor for sensing said target positioned in close proximity thereto.

16. The device, according to claim 14, wherein said first member is a striker and wherein said second member is a switch operable by a contact with said striker.

17. The device, according to claim 10, wherein said means for storing and emitting sound signals and said battery are mounted internal to a cap of said dispenser and wherein said cap further includes at least one aperture formed through a portion thereof and generally aligned with said means for storing and emitting sound signals for promulgating an emitted audible sound external to said soap dispenser.
